(19) United States
(12) Patent Application Publication
(10) Pub. No.: US 2009/0130995 A1
(43) Pub. Date: May 21, 2009

(54) MOBILE COMMUNICATION DEVICE, HOUSING STRUCTURE AND MANUFACTURING METHOD OF HOUSING STRUCTURE

(76) Inventor: Sheng WANG CHEN, Taipei (TW)

Correspondence Address: Muncy, Geissler, Olds & Lowe, PLLC, P.O. BOX 1364, FAIRFAX, VA, 22038-1364, US

(21) Appl. No.: 12/233,290

(22) Filed: Sep. 18, 2008

(30) Foreign Application Priority Data
Nov. 16, 2007 (TW) 096143614

(51) Int. Cl. H04B 1/38; G06F 1/16; B23P 17/04

(52) U.S. Cl. 455/90.3; 29/592.1; 29/600

(57) ABSTRACT

A mobile communication device includes a housing structure and an antenna. The housing structure has a carbon fiber housing portion and a non-conductive fiber housing portion. The antenna is disposed in the housing structure. The signal transceiving portion of the antenna is disposed corresponding to the non-conductive fiber housing portion. A housing structure and a manufacturing method thereof applied to the mobile communication device are also disclosed.

### CROSS REFERENCE TO RELATED APPLICATIONS

This Non-provisional application claims priority under 35 U.S.C. §119(a) on Patent Application No(s). 096143614 filed in Taiwan, Republic of China on Nov. 16, 2007, the entire contents of which are hereby incorporated by reference.

### BACKGROUND OF THE INVENTION

1. Field of Invention

The invention relates to an electronic device, a housing structure and a manufacturing method of a housing structure. More particularly, the invention relates to a mobile communication device, a housing structure and a manufacturing method of a housing structure.

2. Related Art

Recently, various kinds of mobile electronic devices are disclosed with the feature of light and compact, and most of the mobile electronic devices have the communication function. To manufacture lighter mobile communication devices, it is a critical factor to utilize the suitable housing material. Regarding to the present composite materials, the carbon fiber material, which has the advantages of strength and light, has been considered as one of the ideal materials for the housing of the mobile communication device.

As shown in FIGS. 1A and 1B, a conventional mobile communication device 1 includes a first housing 11, a second housing 12, an antenna 13, a third housing 15 and a fourth housing 16. The mobile communication device 1 is, for example, a notebook computer with an antenna. The second housing 12 and the first housing 11 are connected to each other. The third housing 15 and the fourth housing 16 are connected to each other. To reduce the weight of the mobile communication device 1 with keeping enough structure strength of the housing, most of the first housing 11 and the third housing 15 are made of the carbon fiber material. In addition, the first housing 11 and the second housing 12 of the mobile communication device 1 can be assembled with a display module 14 so as to form a display unit 1a. The third housing 15, the fourth housing 16, a host (not shown) and an input module 18, which includes a keyboard 181 and a touch pad 182, form a host unit 1b. The display unit 1a and the host unit 1b are connected by a hinge 19.

As shown in FIG. 1B, the antenna 13 is disposed between the first housing 11 and the second housing 12. The first housing 11 includes a carbon fiber portion 111 and a plastic housing portion 112. The carbon fiber housing portion 111 constructs the most part of the first housing 11, and the plastic housing portion 112 constructs the small part of the first housing 11, which is located corresponding to the antenna 13. Since the carbon fiber material of the carbon fiber housing portion 111 is a good electric conductor, the carbon fiber housing portion 111 may interfere in the transmission of the electromagnetic wave. In order to allow the antenna 13 to transmit and receive signals normally, the first housing 11 is usually manufactured as the following steps. Firstly, a housing made of the carbon fiber material is formed. A part of the housing, which is located corresponding to the antenna 13, is cut off by the following process. Then, the plastic housing portion 112 is disposed on the cut-off part of the first housing 11, which is located corresponding to the antenna 13. Thus, the complex procedure for manufacturing the first housing 11 increases the manufacturing cost.

In addition, since the materials of the plastic housing portion 112 and the carbon fiber housing portion 111 are different, they must be formed separately. Thus, the fixing element M and several screws S are necessary to fix the plastic housing portion 112 to the carbon fiber housing portion 111. This may also increase the material cost and assembling cost. Moreover, when the plastic housing portion 112 is assembled with the carbon fiber housing portion 111, the drop height H or gap G is easily generated. This may affect the flatness of the out surface of the mobile communication device 1.

Therefore, it is an important subject to provide a mobile communication device, a housing structure and a manufacturing method of the housing structure that can replace the conventional housing structure design so as to increase the appearance consistency and decrease the manufacturing cost.

### SUMMARY OF THE INVENTION

In view of the foregoing subject, an object of the invention is to provide a mobile communication device, a housing structure and a manufacturing method of the housing structure that can increase the appearance flatness of the housing structure, which includes the carbon fiber housing portion and another housing portion corresponding to the antenna.

To achieve the above-mentioned object, the invention discloses a mobile communication device including a housing structure and an antenna. The housing structure has a carbon fiber housing portion and a non-conductive fiber housing portion. The antenna is disposed in the housing structure, and a signal transceiving portion of the antenna is disposed corresponding to the non-conductive fiber housing portion.

To achieve the above-mentioned object, the invention also discloses a housing structure, which is applied to a mobile communication device having an antenna. The housing structure includes a carbon fiber housing portion and a non-conductive fiber housing portion connected to the carbon fiber housing portion. The antenna is disposed in the housing structure, and a signal transceiving portion of the antenna is disposed corresponding to the non-conductive fiber housing portion.

To achieve the above-mentioned object, the invention further discloses a manufacturing method of a housing structure. The housing structure is applied to a mobile communication device, which has an antenna. The manufacturing method includes the steps of stacking a plurality of carbon fiber fabrics to form a structure; forming a hollow portion, which is disposed corresponding to a preset signal transceiving portion of the antenna, on the structure; disposing a non-conductive fiber fabric on the structure to cover the hollow portion; and applying a pressure and a temperature to the structure.

As mentioned above, the invention is to form a hollow portion on the stacked carbon fiber fabrics, dispose the non-conductive fiber fabric on the preset position of the antenna, and then mold the carbon fiber fabrics and the non-conductive fiber fabric to integrally form the carbon fiber housing portion and the non-conductive fiber housing portion, which is located corresponding to the transceiving portion of the antenna. Compared with the conventional art, the housing structure of the invention is composed of the carbon fiber material and the non-conductive fiber material instead of the conventional plastic material, so that the appearance consistency of the mobile communication device can be increased. In addition, the weight of the housing structure can be reduced, the housing structure can be thinner, and the manufacturing process can be simplified, thereby decreasing the manufacturing cost.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a conventional mobile communication device;

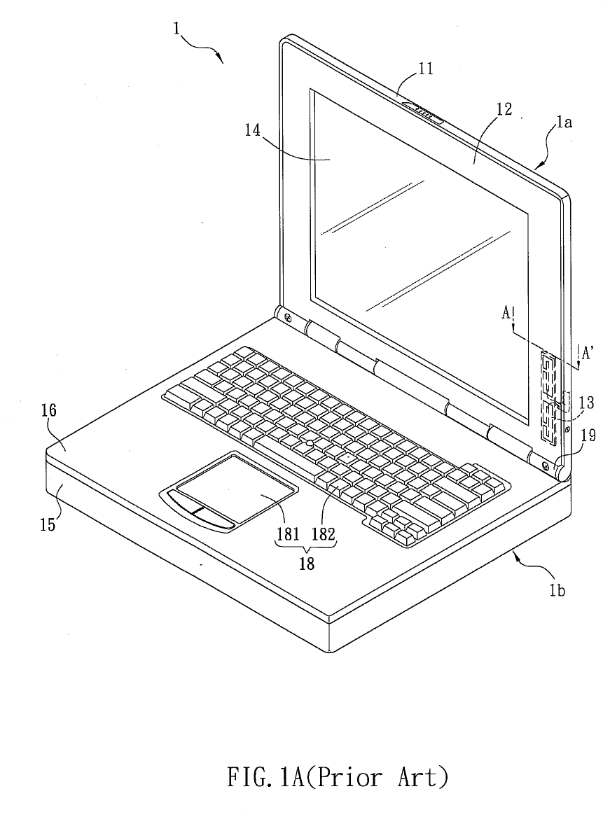

FIG. 1B is a sectional diagram along the line A-A′ of FIG. 1A;

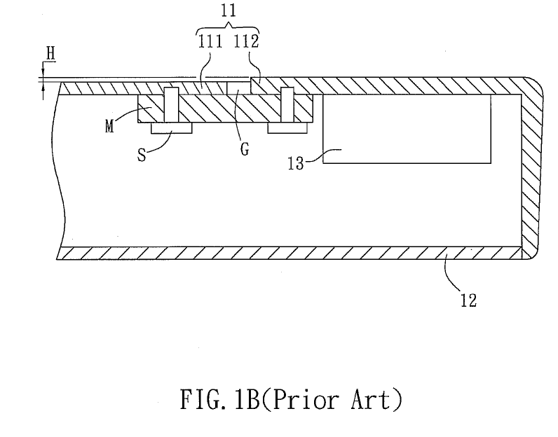

FIG. 2 is an enlarged diagram of a part of a mobile communication device according to a first embodiment of the invention;

FIG. 3 is a flow chart showing a manufacturing method of a housing structure of the mobile communication device according to the invention;

FIG. 4A is an enlarged diagram of a part of a mobile communication device according to a second embodiment of the invention;

FIG. 4B is a schematic diagram showing the closed mobile communication device of FIG. 4A; and

FIG. 5 is an enlarged diagram of a part of a mobile communication device according to a third embodiment of the invention.

### DETAILED DESCRIPTION OF THE INVENTION

The present invention will be apparent from the following detailed description, which proceeds with reference to the accompanying drawings, wherein the same references relate to the same elements.

### First Embodiment

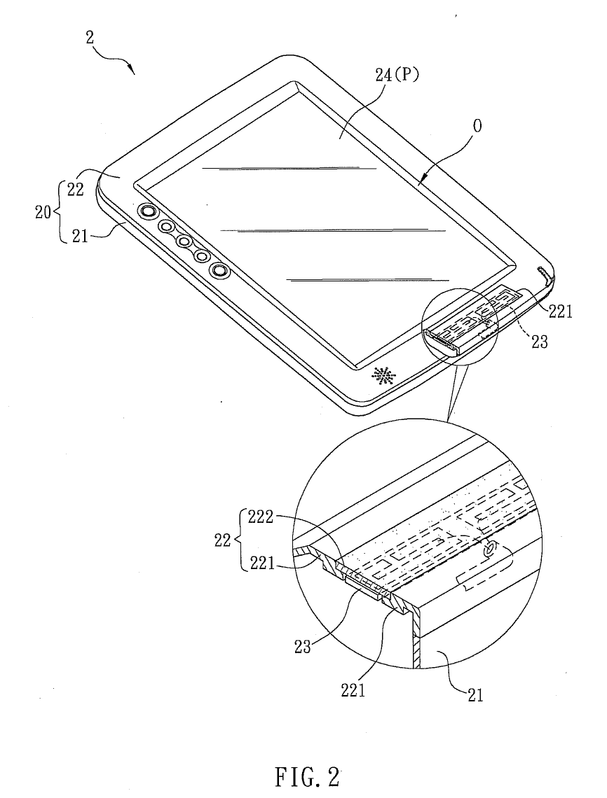

With reference to FIG. 2, a mobile communication device 2 according to a first embodiment of the invention includes a housing structure 20 and an antenna 23. In the embodiment, the mobile communication device 2 can be any communication device with an antenna such as a PDA (Personal Digital Assistant).

The housing structure 20 includes a first housing 21 and a second housing 22. The first housing 21 and the second housing 22 can be connected with each other by wedging, locking or screwing. The material of the first housing 21 can be, for example but not limited to, a carbon fiber, plastic, metal or alloy. The material of the second housing 22 can be a carbon fiber composite material such as, for example but not limited to, a polyacrylonitrile carbon fiber, pitch-based carbon fiber, rayon carbon fiber or their combination. The type of the fiber can be long fiber or short fiber. In addition, the material of the non-conductive fiber housing portion 222 can be a glass fiber, boron fiber, silicon carbide fiber or their combination. In the embodiment, the material of the non-conductive fiber housing portion 222 is preferably a glass fiber.

In the embodiment, the mobile communication device 2 further includes a display module 24 disposed between the first housing 21 and the second housing 22. The second housing 22 has an opening O, and a display surface P of the display module 24 is exposed through the opening O.

The antenna 23 is, for example, a ceramic antenna. Of course, the type and size of the antenna 23 can be designed according to the actual product requirement. The antenna 23 is disposed on the first housing 21 or the second housing 22. In general, the antenna 23 is disposed at the place that is not covered by the display module 24. In the embodiment, the antenna 23 is disposed at the periphery of the second housing 22. The second housing 22 is the operation surface of the mobile communication device 1, so that the second housing 22 is usually disposed upwards. Thus, the electromagnetic waves transmitted or received by the antenna 23 must pass through the second housing 22. In the embodiment, the non-conductive fiber housing portion 222 of the second housing 22 is disposed corresponding to the signal transceiving portion of the antenna 23, so that the signal transceiving function of the antenna 23 can be normally operated.

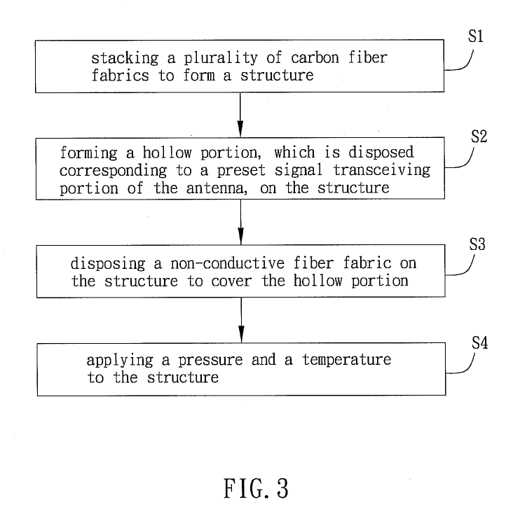

Referring to FIG. 3 in view of FIG. 2, a manufacturing method of the housing structure 20 of the mobile communication device 2 includes the following steps S1 to S4. In the step S1, a plurality of carbon fiber fabrics are stacked to form a structure, such as the first housing 21 as shown in FIG. 2. The carbon fiber fabrics are formed by weaving carbon fibers and then immersing in a resin. The strength of the structure will be increased if the stacked thickness of the carbon fiber fabrics increases. Then, in the step S2, a hollow portion is formed on the structure, such as the first housing 21. Herein, the hollow portion is disposed corresponding to a preset signal transceiving portion of the antenna 23. In the step S3, a non-conductive fiber fabric is disposed on the structure to cover the hollow portion. In the step S4, the structure including the carbon fiber fabrics and the non-conductive fiber fabric is molded and then applied with a pressure and a temperature (thermal compression process). Thus, the carbon fiber housing portion 221 and the non-conductive fiber housing portion 222 can be integrally formed. This can manufacture the first housing 21 with planar appearance, and the manufacturing cost and material cost can be reduced. To be noted, the steps for forming the carbon fiber housing portion 221 and the non-conductive fiber housing portion 222 may be changed. For example, the carbon fiber housing portion 221 may be formed firstly, and then the non-conductive fiber housing portion 222 is formed. In addition, the size, thickness and position of the non-conductive fiber housing portion 222 are not limited and can be designed according to the actual product requirement.

### Second Embodiment

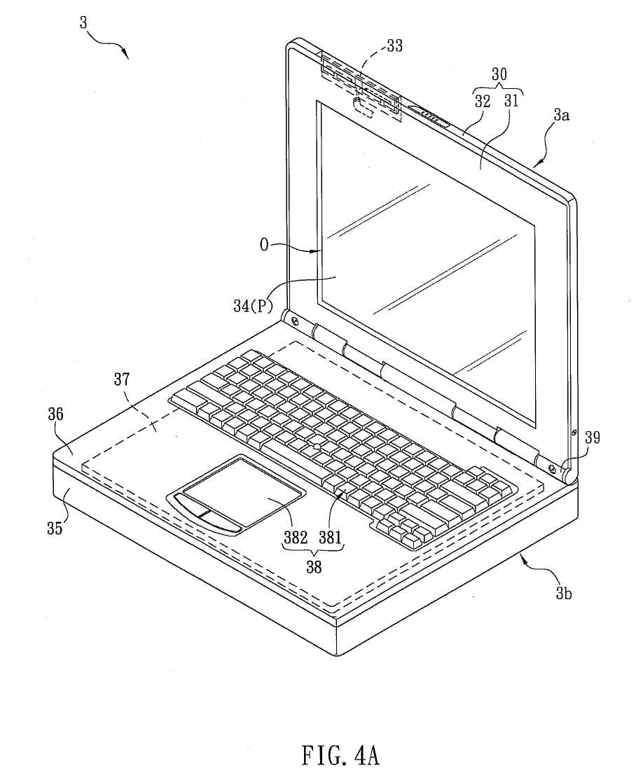

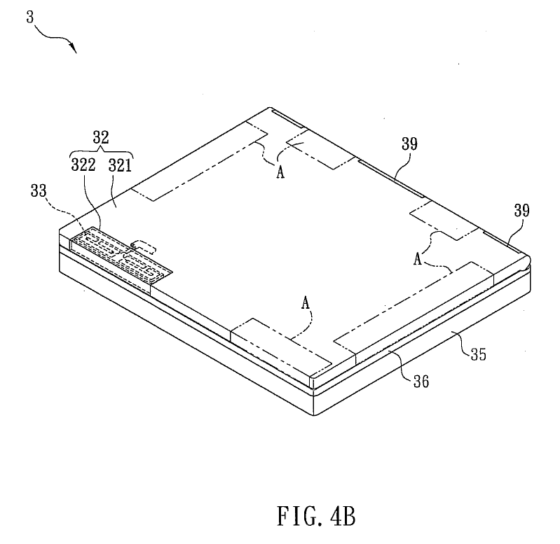

With reference to FIGS. 4A and 4B, a mobile communication device 3 according to a second embodiment of the invention includes an antenna 33 and a housing structure 30. The housing structure 30 includes a first housing 31, a second housing 32, a third housing 35 and a fourth housing 36. In the embodiment, the mobile communication device 3 is, for example, a notebook computer with the communication function.

In the embodiment, the mobile communication device 3 further includes a display module 34 and a host 37. The display module 34 is disposed between the first housing 31 and the second housing 32, and the first housing 31 and the second housing 32 enclose the display module 34. The first housing 31 has an opening O, and a display surface P of the display module 34 is exposed from the opening O. The host 37 is disposed between the third housing 35 and the fourth housing 36, and the third housing 35 and the fourth housing 36 enclose the host 37. The first housing 31, the second housing 32 and the display module 34 form a display unit 3a. The third housing 35, the fourth housing 36 and the host 37 form a host unit 3b. The host unit 3b and the display unit 3a are connected by a hinge 39. In addition, the host unit 3b further includes an input module 38, such as a keyboard 381 and a touch pad 382.

The first housing 31 and the second housing 32 are connected by wedging, locking or screwing. The second housing 32 includes a carbon fiber housing portion 321 and a non-conductive fiber housing portion 322. In the embodiment, the materials and manufacturing methods of the carbon fiber housing portion 321 and the non-conductive fiber housing portion 322 are similar to those of the carbon fiber housing portion 221 and the non-conductive fiber housing portion 222 of the first embodiment, so the detailed descriptions thereof will be omitted. In addition, since the third housing 35 and the fourth housing 36 are not disposed with an antenna, the third housing 35 can be made of a carbon fiber material and the fourth housing 36 can be made of a carbon fiber, plastic, metal or alloy.

The antenna 33 is disposed between the first housing 31 and the second housing 32, and the type and size of the antenna 33 can be designed according to the actual product requirement. In the embodiment, the antenna 33 is disposed at the periphery of the second housing 32. The non-conductive fiber housing portion 322 of the second housing 32 is disposed corresponding to the signal transceiving portion of the antenna 33, so that the signal transceiving function of the antenna 33 can be normally operated. Alternatively, the non-conductive fiber housing portion 322 can be selectively disposed corresponding to one of other areas A. The other areas A are located at the periphery of the second housing 32, such as two sides of the second housing 32, or the areas adjacent to the hinge 39. In addition, the area of the non-conductive fiber housing portion 322 may be equal to or larger than the size of the antenna 33 as shown in FIG. 4B, so that the signal transceiving can be performed normally. To be noted, in order to enhance the transceiving effect of the antenna 33, the first housing 31 may also have a non-conductive fiber housing portion (not shown) disposed corresponding to the antenna 33.

### Third Embodiment

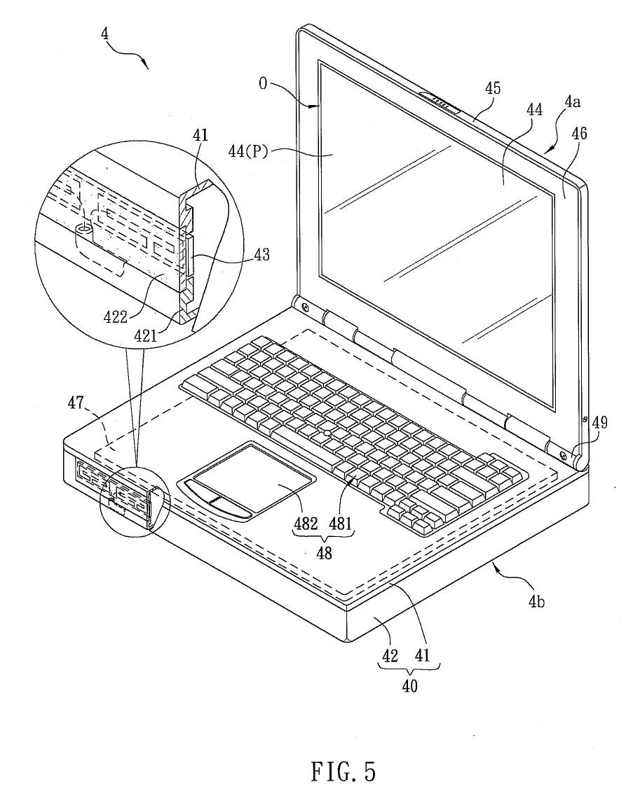

With reference to FIG. 5, a mobile communication device 4 according to a third embodiment of the invention includes an antenna 43 and a housing structure 40. The housing structure 40 includes a first housing 41, a second housing 342, a third housing 45 and a fourth housing 46. In the embodiment, the mobile communication device 4 is, for example, a notebook computer with the communication function.

In the embodiment, the mobile communication device 4 further includes a host 47, an input module 48 and a display unit 4a. The first housing 41, the second housing 42, the host 47 and the input module 48 form a host unit 4b. The first housing 41 and the second housing 42 enclose the host 47. The input module 48 includes a keyboard 481 and a touch pad 482, which are disposed between the first housing 41 and the second housing 42. The difference between the mobile communication device 4 of the third embodiment and the mobile communication device 3 of the second embodiment is in that the mobile communication device 4 includes an antenna 43 disposed in the host unit 4b. In addition, the display unit 4a includes the third housing 45, the fourth housing 46 and a display module 44. The fourth housing 46 includes an opening O and the display surface P of the display module 44 is exposed from the opening O. To be noted, since the third housing 45 and the fourth housing 46 are not disposed with an antenna, the third housing 45 can be made of a carbon fiber material and the fourth housing 46 can be made of a carbon fiber, plastic, metal or alloy.

The materials and manufacturing methods of the carbon fiber housing portion 421 and the non-conductive fiber housing portion 422 are similar to those of the carbon fiber housing portion 321 and the non-conductive fiber housing portion 322 of the second embodiment, so the detailed descriptions thereof will be omitted.

In the embodiment, the antenna 43 can be selectively disposed at the periphery of the second housing 42. Similarly, the non-conductive fiber housing portion 422 can be disposed at the periphery of the second housing corresponding to the antenna 43, and the carbon fiber housing portion 421 and the non-conductive fiber housing portion 422 can be integrally formed. Thus, the signal transceiving function of the antenna 43 can be performed normally, and the appearance flatness of the mobile communication device 4 can be increased.

To sum up, the invention is to form a hollow portion on the stacked carbon fiber fabrics, dispose the non-conductive fiber fabric on the preset position of the antenna, and then mold the carbon fiber fabrics and the non-conductive fiber fabric to integrally form the carbon fiber housing portion and the non-conductive fiber housing portion, which is located corresponding to the transceiving portion of the antenna. Compared with the conventional art, the housing structure of the invention is composed of the carbon fiber material and the non-conductive fiber material instead of the conventional plastic material, so that the appearance consistency of the mobile communication device can be increased. In addition, the weight of the housing structure can be reduced, the housing structure can be thinner, and the manufacturing processes can be simplified, thereby decreasing the manufacturing cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A mobile communication device, comprising:
a housing structure having a carbon fiber housing portion and a non-conductive fiber housing portion; and
an antenna disposed in the housing structure, wherein a signal transceiving portion of the antenna is disposed corresponding to the non-conductive fiber housing portion.

2. The device according to claim 1, wherein a material of the carbon fiber housing portion comprises a carbon fiber composite material.

3. The device according to claim 2, wherein the carbon fiber composite material comprises a polyacrylonitrile carbon fiber, a pitch-based carbon fiber, a rayon carbon fiber or their combination.

4. The device according to claim 1, wherein a material of the non-conductive fiber housing portion comprises a glass fiber, a boron fiber, a silicon carbide fiber or their combination.

5. The device according to claim 1, wherein the carbon fiber housing portion and the non-conductive fiber housing portion are integrally formed.

6. The device according to claim 1, wherein the housing structure comprises a first housing and a second housing.

7. The device according to claim 6, further comprising:
a display module disposed between the second housing and the first housing, wherein the first housing or the second housing has an opening, and a display surface of the display module is exposed through the opening.

8. A housing structure applied to a mobile communication device having an antenna, the housing structure comprising:
a carbon fiber housing portion; and
a non-conductive fiber housing portion connected to the carbon fiber housing portion, wherein the antenna is disposed in the housing structure, and a signal transceiving portion of the antenna is disposed corresponding to the non-conductive fiber housing portion.

9. The housing structure according to claim 8, wherein a material of the carbon fiber housing portion comprises a carbon fiber composite material.

10. The housing structure according to claim 9, wherein the carbon fiber composite material comprises a polyacrylonitrile carbon fiber, a pitch-based carbon fiber, a rayon carbon fiber or their combination.

11. The housing structure according to claim 8, wherein a material of the non-conductive fiber housing portion comprises a glass fiber, a boron fiber, a silicon carbide fiber or their combination.

12. The housing structure according to claim 8, wherein the carbon fiber housing portion and the non-conductive fiber housing portion are integrally formed.

13. The housing structure according to claim 8, wherein the housing structure comprises a first housing and a second housing.

14. The housing structure according to claim 13, wherein the mobile communication device further comprises:
a display module disposed between the second housing and the first housing, wherein the first housing or the second housing has an opening, and a display surface of the display module is exposed through the opening.

15. A manufacturing method of a housing structure, the housing structure being applied to a mobile communication device having an antenna, the method comprising steps of:
stacking a plurality of carbon fiber fabrics to form a structure;
forming a hollow portion on the structure, wherein the hollow portion is disposed corresponding to a preset signal transceiving portion of the antenna;
disposing a non-conductive fiber fabric on the structure to cover the hollow portion; and
applying a pressure and a temperature to the structure.

16. The method according to claim 15, wherein a material of the carbon fiber fabric comprises a carbon fiber composite material.

17. The method according to claim 16, wherein the carbon fiber composite material comprises a polyacrylonitrile carbon fiber, a pitch-based carbon fiber, a rayon carbon fiber or their combination.

18. The method according to claim 15, wherein a material of the non-conductive fiber housing portion comprises a glass fiber, a boron fiber, a silicon carbide fiber or their combination.
